(19) United States
(12) Patent Application Publication
(10) Pub. No.: US 2010/0199827 A1
(43) Pub. Date: Aug. 12, 2010

(54) Cutting Table Cutting Tool Assembly

(76) Inventor: James Colegrove, Lake Mills, WI (US)

Correspondence Address: BOYLE FREDRICKSON S.C., 840 North Plankinton Avenue, MILWAUKEE, WI, 53203, US

(21) Appl. No.: 12/369,094

(22) Filed: Feb. 11, 2009

(51) Int. Cl. B26D 1/00

(52) U.S. Cl. 83/651; 29/428

(57) ABSTRACT

A cutting tool assembly that includes a holder that supports a blade for use with cutting tables. At least one roller is attached to the holder and extends beyond a perimeter of the holder in a direction that is normal to an axis of rotation of the roller. The blade extends from the holder in a common direction with the roller and includes a cutting edge that is oriented in a direction that is generally normal to the axis of rotation of the roller. During a cutting process, the roller maintains the position of the material with respect to the sharpened edge of the blade.

### BACKGROUND OF THE INVENTION

The present invention relates to cutting table cutters and, more specifically, to a cutting tool having a bladed cutting tool and at least one roller that maintains the position of a material being cut relative to the blade during cutting operations.

Many manufacturers of a wide variety of parts in a variety of industries are familiar with automated CNC cutting tables. Commonly, a material from which a part is to be produced or cut is placed upon a cutting table. A computer controls movement of a cutting tool relative to the material. One or more of the table, the material, and/or the cutting head is moved in a computer controlled manner so as to maximize the number of parts that can be generated from the available base material. Many appreciate the ability of such systems to produce a variety of parts, from a variety of materials, and in a quality, repeatable, and economic manner.

A number of cutting tool assemblies are available for use with such automated cutting systems. Such cutting tool assemblies are provided in various configurations and have various constructions that are intended to improve cutting efficiency and cut quality as a function of the material being cut as well as specific aspects of the cutting process, such as cut turn radii and the like. Many of these tools can be classified in several general categories. One such category includes those tool assemblies wherein a cutting blade reciprocates in a sawing motion during a cutting operation. FIG. 7 shows a cutting tool assembly 10 indicative of another category of cutting tools; those tools equipped with a stationary knife 12. As shown in FIG. 7, knife 12 is oriented in a tangential direction relative to a cut direction, indicated by cutting edge 22. Such tools commonly include a mount body 14 that is securable to a moveable mandrel of a cutting table by a fastener 16. A fastener 18 and a support block 20 secure knife 12 to body 14.

Cutting tool assembly 10 is commonly used for cutting a variety of single ply materials. Such an assembly has been particularly accepted for cutting difficult to cut materials such as pre-pregnated composite materials, such as carbon fiber and/or plastic based materials. Such materials have a variety of applications including the formation of a number of bicycle components including frame and/or accessory structures.

When cutting such generally rigid materials, knife 12 is generally formed of a carbide material so as to maintain a useable cutting edge 22 for a number of cutting cycles. A shoe or pressure foot 24 is secured by a fastener 26 to mount body 14 at a position proximate knife 12 and can be used to define a cutting depth associated with operation of knife 12. A contact face 28 of pressure foot 24 is maintained in contact with the material being cut during the cutting operation to maintain the position of the material relative to the knife. Due to the translational association of contact face 24 to the material, contact face 28 is coated with a low friction material, such as polytetrafluoroethylene, so that pressure foot 24 can slide across the surface of the material being cut while applying a downward pressure thereto.

Unfortunately, such cutting tools have proven inadequate for efficiently and repeatably generating quality cut parts from composite materials. As pressure foot 24 slides across the material being cut, particulates of cut material and or backing materials collect on contact face 28 of pressure foot 24. This collection of microscopic debris propagates in the form of a resin-like material that adversely affects the desired low friction interaction between the contact face 28 and the material being cut. The increased friction associated with the resin-like material requires that the cutting table machine operate at higher loads to continue to perform similar cutting operations. Furthermore, the increased friction between pressure foot 24 and the cutting material detracts from cut quality and/or requires that parts be produced with greater than desired cut tolerances.

A cutting tool assembly 40 associated with another category of cutting tools is shown in FIGS. 8 and 9. This category of cutting tool assemblies 40 includes a rotatable blade or cutting wheel 42 that has a 360 degree cutting edge 44. A mount body 46 receives a bearing 48 and supports cutting wheel 42 in a cantilevered fashion. A pair of plates 50 laterally support cutting wheel 42. A fastener 52, a sleeve 54, and a nut 56 secure cutting wheel 42 to mount body 46 so that cutting wheel 42 is free to rotate relative to the mount body 46 as it is translates over a material 58 being cut. A bottom surface 60 of mount body 46 can be maintain in an offset relation relative to material 58 if the material is otherwise positionally attached to the cutting table. Alternatively, surface 60 may be coated with a low friction material, such as polytetrafluoroethylene, so that the bottom surface 60 of mount body 46 can apply a downward holding pressure to material 58 without adversely translating material 58 during a cutting operation. Although such wheel-type cutting tool assemblies have proven beneficial for cutting generally light weight materials such as fabric, cloths, and or leather materials, such tools have proven inadequate for use with many harder to cut materials such as composite materials.

Accordingly, there is a need for a cutting table cutting tool assembly that can maintain the position of a generally rigid material relative to a cutting edge, is capable of extended cutting use, and does not unduly interfere with efficient operation of the cutting table system.

### SUMMARY OF THE INVENTION

The present invention provides a cutting table cutting tool assembly that addresses one or more of the problems discussed above. According to one aspect of the invention, a cutting table cutting tool assembly is disclosed that includes a holder that supports a blade. At least one roller is attached to the holder and extends beyond a perimeter of the holder in a direction that is normal to an axis of rotation of the roller. The blade extends from the holder in the same direction as the roller and includes a cutting edge that is oriented in a plane that is generally normal to the axis of rotation of the roller. During a cutting process, the roller maintains the position of the material with respect to the cutting edge of the blade thereby improving the performance of the cutting process.

Another aspect of invention useable with one or more of the above aspects discloses a cutting table cutting tool assembly that includes a body having a first end for being secured to a mandrel of a cutting table system and a second end that is opposite the first end. A guide is attached to the second end of the body and has a material facing surface that is directed away from the second end of the body. A blade is attached to the body such that it extends beyond the material facing surface of the guide. At least one roller is attached to the guide and extends beyond the material facing surface of the guide in a direction aligned with blade. The roller maintains a desired tension on the material be cut so that the blade can pass therethrough without translating the material.

Another aspect of the invention usable with one or more of the above aspects discloses a cutting tool assembly for use with cutting table systems. The cutting tool assembly includes a holder that is constructed to engage a cutting table system. A shoe having an opening is attached to the holder. A knife is attached to the holder and extends through the opening and beyond an edge of the shoe. A cutting edge is formed along a portion of the knife that extends beyond the shoe. A first roller and a second roller are attached to the shoe and generally flank the knife. Each roller has an outer race that extends beyond the shoe proximate the cutting edge and secures the material being cut as the knife performs a cutting operation.

A further aspect of the invention that is combinable with one or more of the above aspects discloses a method of forming a cutting table system cutter assembly. A mount body is formed to cooperate with a cutting table system and a knife blade is attached to the mount body. A shoe is attached to the mount body so that a tip of the knife blade extends beyond a bottom surface of the shoe. At least one roller is attached to the shoe so that a surface of the roller that contacts a material to be cut is located between the tip of the knife blade and the bottom surface of the shoe in a direction generally perpendicular relative to a cutting direction.

Preferably, another aspect of the invention that is combinable with one or more of the above aspects includes providing a pair of rollers that generally flank the blade of knife of the cutting tool assembly. Preferably, both rollers extend a common distance beyond the guide or shoe so that an outer edge of the rollers is positioned between a tip of the blade and a bottom surface of the shoe. More preferably, the pair of rollers rotate about a common axis.

Another aspect of the invention combinable with one or more of the above aspects includes forming a cutting edge on a portion of the knife or blade and orienting the cutting edge so that it is canted or tilted relative to a plane of the cutting material. Preferably, the cutting edge is oriented in a plane that is perpendicular to an axis of rotation of the rollers.

### BRIEF DESCRIPTION OF THE DRAWINGS

The drawings illustrate one preferred embodiment presently contemplated for carrying out the invention. In the drawings:

FIG. 1 is perspective view of a cutting table system equipped having a movable mandrel equipped with a cutting tool assembly according to the present invention;

FIG. 2 is a perspective view of the mandrel and cutting tool assembly shown in FIG. 1;

FIG. 3 is a perspective view of the cutting table cutting tool assembly shown in FIG. 1;

FIG. 4 is an exploded perspective view of the cutting tool assembly shown in FIG. 3;

FIG. 5 is a perspective view of another side of a shoe portion of the cutting tool assembly shown in FIG. 4;

FIG. 6 is a front side elevation view of the cutting tool assembly shown in FIG. 3 with a roller and a portion of the shoe shown in cross section;

FIG. 7 shows one prior art cutting table cutting tool assembly; and

FIGS. 8 and 9 shows another prior art cutting table cutting tool assembly.

In describing the preferred embodiments of the invention that are illustrated in the drawings, specific terminology will be resorted to for the sake of clarity. However, it is not intended that the invention be limited to the specific terms so selected and it is to be understood that each specific term includes all technical equivalents that operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENT

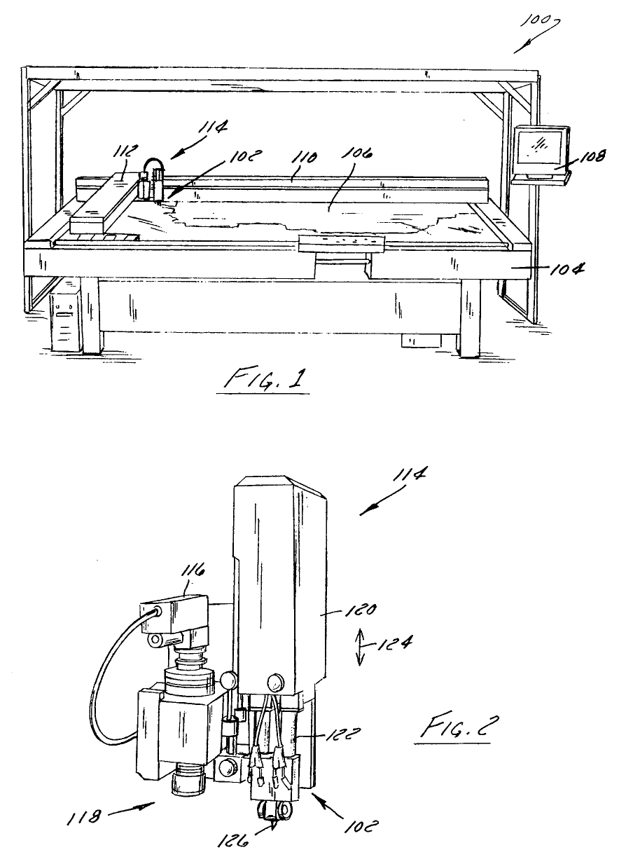

FIG. 1 shows a cutting table system 100 that is equipped with a cutting tool assembly 102 according to the present invention. Cutting table system 100 includes a cutting bed or table 104 that is configured to support a material 106 that is to be cut. A computer 108 controls movement of a horizontal arm 110 and a vertical arm 112 that travel over table 104. A cutting head or mandrel 114 is supported by arms 110, 112 in a manner such that mandrel 114 can be moved across cutting table 104. That is, translation of arms 110, 112 relative to table 104 translates mandrel 114 and cutting tool assembly 102 relative to material 106. As described further below with respect to FIG. 2, mandrel 114 also enables up and down movement of cutting tool assembly 102 relative to material 106.

FIG. 2 shows mandrel 114 removed from cutting table system 100. An optional position system 116 includes a sensor 118 that is configured to monitor and communicate a position of mandrel 114 to computer 108 of cutting table system 100. It is understood that sensor 118 can be any of a photo sensor, a laser sensor, and/or other physical proximately sensors such as variable output limit switches that physically contact cutting material 106. It is further appreciated that some cutting table systems are equipped with computer control systems that are so sophisticated and/or can be configured to produce parts with acceptable tolerances that the providing such a position verification system proves redundant and/or unnecessary.

Mandrel 114 includes an actuator 120 having a movable shaft 122. Shaft 122 translates in an up and down direction, indicated by arrow 124. Cutting tool assembly 102 is attached to shaft 122 such that cutting tool assembly 102 also moves in up and down direction 124 with shaft 122. Such an association allows the cutting edge of cutting tool assembly 102 to be translated relative to material 106 in a cutting and a non-cutting orientation. That is, when oriented in a cutting position, a knife or a blade 126 of cutting tool assembly 102 engages material 106 such that translation of mandrel 114 via manipulation of arms 110, 112 results in blade 126 cutting material 106. When oriented in a non-cutting or raised position, blade 126 is maintained at an offset distance above material 106 such that translation of mandrel 114 by movement of arms 110, 112 translates blade 126 relative to material 106 in a manner that does not cut the material. Such operation allows for efficient cutting of desired shapes and cutting of multiple parts with efficient utilization of material 106 without repositioning of material 106 relative to table 104.

Those skilled in the art will appreciate that cutting table system 100 is merely exemplary of one of many types of cutting table systems useable with the present invention. Understandably, cutting table system 100 is exemplary of one automated cutting system whose operation can be improved with use of cutting tool assembly 102. It is appreciated that other cutting table systems configured in other manners of translating the material relative to the cutting tool assembly are envisioned and within the scope of appending claims. That is, it is appreciated that other cutting table systems exist wherein a cutting table can be translated relative to a more stationary cutting tool, systems wherein the material can be translated relative to a cutting tool, systems wherein a cutting tool is manipulated by a multi-jointed unitary arm, and/or various combinations of such cutting table features.

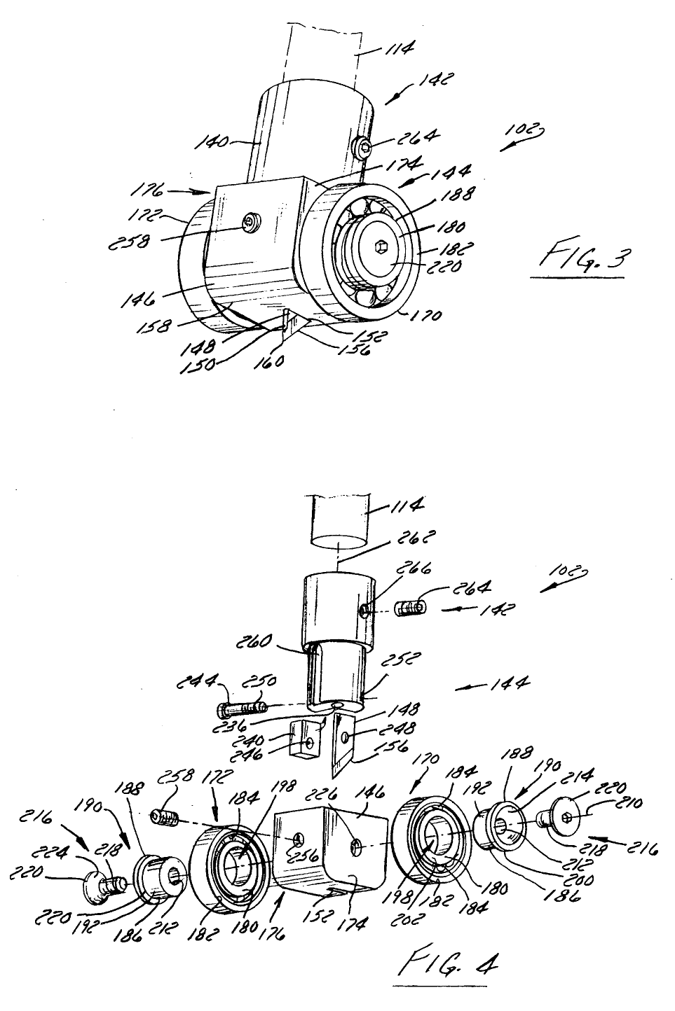

FIG. 3 shows cutter assembly or cutting tool assembly 102 removed from cutting table system 100. Cutting tool assembly 102 includes a body, a mount body, a tool or blade holder, or holder 140 that has a first portion or end 142 and a second or lower portion or end 144. First end 142 of holder 140 is configured to cooperate with mandrel 114 of cutting table system 100. Second end 144 of holder 140 cooperates with a foot, guide, or shoe 146. A knife or blade 148 is secured to holder 140 and is positioned so that an exposed portion 151 of blade 148 passes through a slot or opening 152 formed in shoe 146.

A cutting edge 156 that is formed along a portion of blade 148. Cutting edge 156 is generally inclined with respect to a material facing surface 158 of shoe 146. Preferably, a distal end 160 of blade 148 is offset from material facing surface 158 of shoe 146 a distance that is sufficient to allow distal end 160 to pass entirely through material 106 without shoe 146 coming into contact with material facing surface 158 of shoe 146.

As shown in FIGS. 3 and 4, a first pressure wheel or roller 170 and a second pressure wheel or roller 172 are positioned on generally opposite lateral sides 174, 176 of shoe 146. It is appreciated that cutting tool assembly 102 may be equipped with only one roller for those applications wherein one roller is sufficient to maintain a desired orientation of material 106 relative to blade 148.

Rollers 170, 172 each include an inner race 180 and an outer race 182 that are separated by a number of roller elements or bearings 184. Inner race 180 of each roller 170, 172 is supported by a post or a hub 186 that is attached to shoe 146. A rib or lip 188 is formed proximate an end 190 of each hub 186.

A first portion 192 of each hub 186 is constructed to pass through an opening 198 formed in each inner race 180 of each roller 170, 172. Each lip 188 has a diameter that is larger than a diameter of a respective first portion 192 of each hub 186. First portion 192 of each hub 186 passes through the opening 198 of a respective hub 186. A vertical portion 200 of each lip 188 cooperates with a side surface 202 of each inner race 180 of a respective roller 170, 172 so as to generally fix the position of rollers 170, 172 relative to shoe 146 in a direction generally aligned with an axis of rotation 210 of rollers 170, 172. Preferably, rollers 170, 172 are similarly sized so that each outer races 182 rotates about axis 210. It is appreciated that rollers 170, 172 could have dissimilar sizes and would therefore have separate axis of rotation.

An opening 212 is formed in each hub 186 and includes a chamfered or tapered section or portion 214 that is formed proximate each lip 188. A fastener 216 having a threaded portion 218 and a head portion 220 secures each of hubs 186 to shoe 146. Preferably, each head portion includes a chamfered or tapers section 224 that cooperates with the tapered portion 214 of the respective hub 186. Such a construction ensures that each hub 186 is centered relative to axis 210.

Threaded portion 218 of each fastener 216 threadingly cooperates with an opening 226 formed in the respective opposite lateral side 174, 176 of shoe 146. Fasteners 216 cooperate with shoe 146 in a manner so that fasteners 216 do not interfere with or otherwise alter the position of blade 148 relative to holder 140. Alternatively, rather than securing hubs 186 to shoe 146 with fasteners 216, each hub 186 could be formed integrally with shoe 146 or be configured to directly engage a corresponding opening formed in shoe 146 thereby omitting the use of fasteners 216.

It is appreciated that, regardless of the specific construction of hubs 186, rollers 170, 172 could be engaged/disengaged from respective hubs 186 via translation of the respective hub/roller in a lateral outward direction generally aligned with axis 210. It is further appreciated that hub 186 need not be provided with lip 188 provided fasteners 216 secure a locking ring and/or plate washer to the respective hub 186 outboard of the respective hub so as to maintain the lateral position of rollers 170, 172 relative to shoe 146.

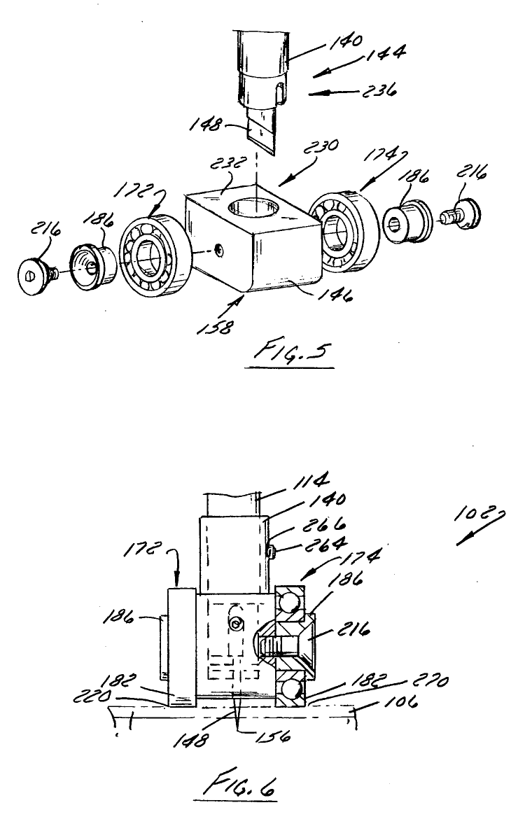

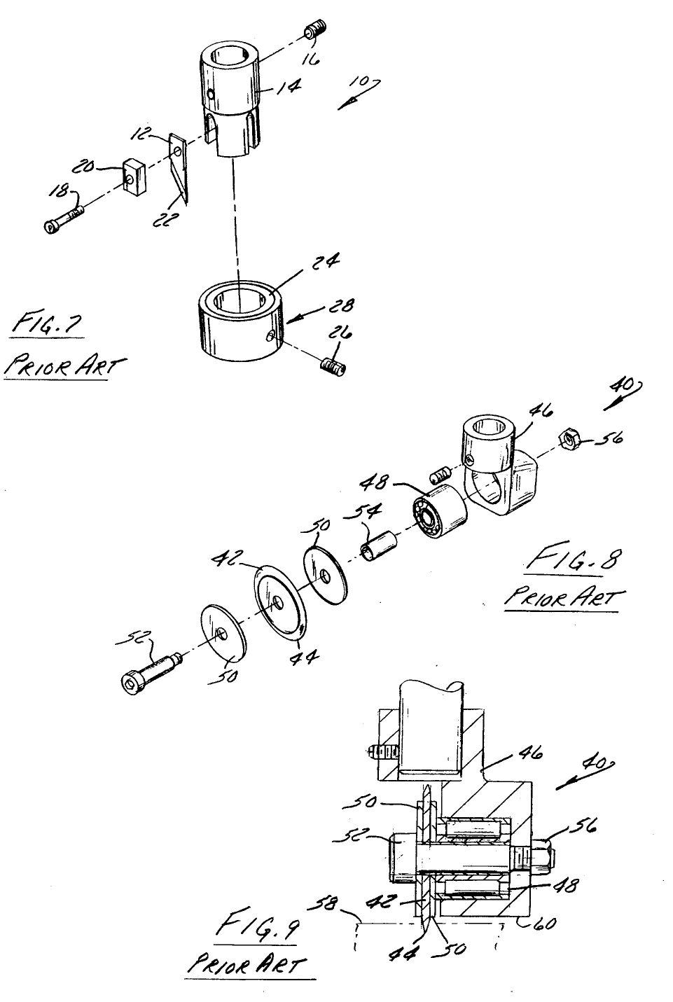

Referring to FIGS. 4 and 5, shoe 146 includes a cavity 230 that is formed in an upward facing side 232 of shoe 146. Upward facing side 232 of shoe 146 is defined as being generally opposite the material facing surface 150 of shoe 146. Cavity 230 is generally shaped to accommodate lower portion 144 of holder 140 being positioned in the cavity 230. The lower portion 144 of holder 140 includes a recess 236 that is constructed to accommodate blade 148 and a backer or support block or support 240. Support 240 ensures blade 148 is securely supported by holder 140. Blade 148 and support 240 are received in recess 236 so as to be generally positioned within a footprint of cavity 230. Such an orientation allows shoe 146 to translate in a direction that is generally aligned with a longitudinal axis of holder 140.

A fastener 244 passes through an opening 246 formed in support block 240 and an opening 248 formed in blade 148. A threaded portion 250 a fastener 244 threadingly engage an opening 252 formed in second portion 144 of holder 140 and secures blade 148 and support block 240 to holder 140. As shown in FIG. 4, shoe 146 includes a forward facing opening 256 that cooperates with a fastener, such as a set screw 258. Set screw 258 cooperates with opening 256 and slidably engages an index or a groove or channel 260 formed in holder 140. Channel 260 is generally aligned with a longitudinal axis 262 of holder 140 and is generally aligned with a longitudinal axis of blade 148. Set screw 258 and channel 260 allow a user to select a desired distance that blade 148 protrudes beyond shoe 146.

Cutting edge 156 of blade 148 is oriented in a crossing direction relative to longitudinal axis 262 of holder 140. Said in another way, cutting edge 156 is oriented in a crossing direction relative to a plane of material 106. Axis 262 and channel 260 are oriented to be generally perpendicular to the plane of material 106. Such an orientation ensures an efficient cutting operation as cutting edge 156 moves through material 106 in both a piercing direction that is generally perpendicular to the plane of the material and a cutting direction within the plane of material 106.

As shown in FIGS. 4 and 6, a fastener, such as a set screw 264, cooperates with an opening 266 formed in holder 140 and secures cutting tool assembly 102 to mandrel 114. Referring to FIG. 6, when oriented in a cutting position, rollers 170, 172 engage material 106 so as to generally flank the cutting edge 156 of blade 148. As cutting tool assembly 102 translates relative to material 106, outer races 182 rotate such that a contact area 270 forms between each roller 170, 172 and material 106. As cutting tool assembly 102 moves, each outer race 182 rotates relative to material 106. Such a configuration maintains a desired holding pressure for the cutting operation while reducing the drag inference between cutting tool assembly 102 and material 106.

Accordingly, cutting tool assembly 102 reduces the counter-productive frictional forces generated by the sliding of a pressure foot across the cutting material associated with the prior art cutting table cutting tool assemblies. Accordingly, cutting table cutting tool assembly 102 improves cutting speed, improves cutting precision, attains improved cutting blade operating life, requires less cutting table generated down or holding pressures, and achieves an overall improvement in cutting table performance and operation.

Therefore, one embodiment of the invention includes a cutting table cutting tool assembly that includes a body having a first end that is securable to a mandrel of a cutting table system and a second end opposite the first end. A guide is attached to the second end of the body and has a material facing surface that is directed away from the second end of the body. A blade is attached to the body such that it extends beyond the material facing surface of the guide. At least one roller is attached to the guide and extends beyond the material facing surface of the guide in a direction aligned with blade.

Another embodiment of the invention that includes or is combinable with one or more of the features or aspects of the embodiment above includes a cutting tool assembly that includes a holder constructed to engage a cutting table system. A shoe is attached to the holder and has an opening formed therethrough. A knife is attached to the holder and extends beyond the opening formed in the shoe. A cutting edge is formed along a portion of the knife that extends beyond the shoe. A first roller and a second roller are attached to the shoe and generally flank the knife. Each roller has an outer race that extends beyond the shoe proximate the cutting edge.

Another embodiment of the invention that includes or is combinable with one or more of the features or aspects of the embodiments above includes a method of forming a cutting table system cutter assembly. A mount body is formed to cooperate with a cutting table system and a knife blade is attached to the mount body. A shoe is attached to the mount body so that a tip of the knife blade extends beyond a bottom surface of the shoe. At least one roller is attached to the shoe so that a surface of the roller that contacts a material to be cut is located between the tip of the knife blade and the bottom surface of the shoe in a direction generally perpendicular relative to a cutting direction.

The present invention has been described above in terms of the preferred embodiment. It is recognized that various alternatives and modifications may be made to these embodiments which are within the scope of the appending claims.

What is claimed is:

1. A cutting table cutting tool assembly comprising:
a body having a first end for being secured to a mandrel of a cutting table system and a second end opposite the first end;
a guide attached to the second end of the body and having a material facing surface directed away from the second end of the body;
a blade attached to the body and extending beyond the material facing surface of the guide; and
at least one roller attached to the guide and extending beyond the material facing surface of the guide in a direction aligned with blade.

2. The assembly of claim 1 further comprising another roller attached to the guide so that the at least one roller and another roller flank opposite sides of the blade.

3. The assembly of claim 2 wherein the at least one roller and another roller extend the same distance beyond the material facing surface of the guide.

4. The assembly of claim 1 further comprising a fastener and support that secures the blade to the body.

5. The assembly of claim 4 further comprising a cavity formed in the guide and shaped to slidably receive the fastener and the support therein.

6. The assembly of claim 5 further comprising a groove formed in the guide and positioned to allow at least a portion of a cutting edge of the blade to pass therethrough when the support is positioned in the cavity.

7. A cutting tool assembly for use with cutting table systems, the cutting tool assembly comprising:
a holder constructed to engage a cutting table system;
a shoe attached to the holder;
an opening formed through the shoe;
a knife attached to the holder and extending beyond the opening formed in the shoe;
a cutting edge formed along a portion of the knife that extends beyond the shoe; and
a first roller and a second roller attached to the shoe so as to generally flank the knife, each roller having an outer race that extends beyond the shoe proximate the cutting edge.

8. The assembly of claim 7 wherein the cutting edge extends an operating distance beyond a perimeter of each outer race in a direction perpendicular to an axis of rotation of each outer race.

9. The assembly of claim 8 wherein the knife is attached to the holder so that the cutting edge is tilted so that only a portion of the cutting edge extends beyond the shoe.

10. The assembly of claim 7 wherein the cutting edge extends in a direction that is generally perpendicular to an axis of rotation of one of the first and second rollers.

11. The assembly of claim 7 wherein each roller is attached to the shoe so as to rotate about a common axis.

12. The assembly of claim 7 further comprising a post attached to the shoe and constructed to engage an inner race of each of the first and second rollers.

13. The assembly of claim 12 further comprising a lip formed proximate an end of each post and constructed to prevent translation of a respective roller in a direction generally aligned with an axis of rotation of the respective roller.

14. The assembly of claim 13 further comprising a fastener for securing each post to the shoe.

15. A method of forming a cutter assembly for use with cutting table systems comprising:
forming a mount body to cooperate with a cutting table system;
attaching a knife blade to the mount body;
attaching a shoe to the mount body so that a tip of the knife blade extends beyond a bottom surface of the shoe; and
attaching at least one roller to the shoe so that a surface of the roller that contacts a material to be cut is located between the tip of the knife blade and the bottom surface of the shoe in a direction generally perpendicular relative to a cutting direction.

16. The method of claim 15 wherein attaching the knife blade to the mount body includes providing a support that extends along a portion of the knife blade and on a side of the knife blade opposite the mount body.

17. The method of claim 15 further comprising attaching another roller to a side of the shoe opposite the at least one roller.

18. The method of claim 17 further comprising attaching each roller with a hub that passes through each respective roller.

19. The method of claim 18 further comprising forming a lip on at least one end of each hub, each lip restricting motion of a respective roller relative to the shoe in a direction that crosses an axis of the knife blade.

20. The method of claim 15 further comprising providing an index for positioning the relative to the mount body.
